(19) United States
(12) Patent Application Publication
(10) Pub. No.: US 2026/0118050 A1
(43) Pub. Date: Apr. 30, 2026

(54) HORIZONTAL INTELLIGENT VENDING FREEZER AND GOODS IDENTIFICATION METHOD THEREFOR

(71) Applicant: QINGDAO HIRON COMMERCIAL COLD CHAIN CO., LTD., QINGDAO (CN)

(72) Inventors: HONGKUI MA, QINGDAO (CN); YONGJIE XU, QINGDAO (CN); SHANMIN YIN, QINGDAO (CN); YONGJUN ZHANG, QINGDAO (CN); RUIXIANG ZHANG, QINGDAO (CN); XIUHUA XIANG, QINGDAO (CN)

(73) Assignee: QINGDAO HIRON COMMERCIAL COLD CHAIN CO., LTD., QINGDAO (CN)

(21) Appl. No.: 19/429,912

(22) Filed: Dec. 22, 2025

Related U.S. Application Data
(63) Continuation of application No. PCT/CN2024/101228, filed on Jun. 25, 2024.

(30) Foreign Application Priority Data
Jul. 13, 2023 (CN) 202321847028.X
Aug. 31, 2023 (CN) 202311115419.7
Aug. 31, 2023 (CN) 202311120417.7
Nov. 16, 2023 (CN) 202311532365.4
Nov. 16, 2023 (CN) 202323094356.X
Jan. 17, 2024 (CN) 202420116281.6

(51) Int. Cl. F25D 29/00

(52) U.S. Cl. CPC F25D 29/00; F25D 2700/06

(57) ABSTRACT

A horizontal intelligent vending freezer and goods identification method therefor, wherein, the freezer comprised a freezer body, provided with an accommodating chamber therein; a visual identification device, configured to collect image information of vending processes, disposed in the accommodating chamber and connected with an inner wall of the freezer body; gravity sensors, configured to monitor weight change information of the goods in the freezer body before and after sale; and a controller, connected with the visual identification device and the gravity sensors; the controller stores types of the goods to be sold and corresponding weight information for each type of goods, and is configured to determine a type and quantity of sold goods based on the weight change information of the goods in the freezer body before and after sale monitored by the gravity sensors and the image information of the vending process collected by the visual identification device, and combined with the stored types of goods and the corresponding weight information for each type of goods. The freezer adopts a combination of vision and gravity sensing to identify sold goods, achieving high accuracy.

### CROSS-REFERENCE TO RELATED APPLICATIONS

The present application is a continuation of the international application PCT/CN2024/101228, filed on Jun. 25, 2024, which claims the priority benefits of the Chinese application 202321847028.X, filed on Jul. 13, 2023 and entitled “Freezer with Advertising Machine/Face Recognition Screen”; the Chinese application 202311120417.7, filed on Aug. 31, 2023 and entitled “Horizontal Intelligent Vending Freezer and Vending Goods Identification Method Therefor”; the Chinese application 202311115419.7, filed on Aug. 31, 2023 and entitled “Horizontal Intelligent Vending Freezer and Sales Method thereof”; the Chinese application 202311532365.4, filed on Nov. 16, 2023 and entitled “Goods Identification System for Smart Vending Freezer and Goods Identification Method”; the Chinese application 202323094356.X, filed on Nov. 16, 2023 and entitled “Bottom Support Assembly for Smart Vending Freezer and Smart Vending Freezer”; and the Chinese application 202420116281.6, filed on Jan. 17, 2024 and entitled “Detachable and Foldable Basket”; the entirety of the above identified applications is hereby incorporated by reference.

### TECHNICAL FIELD

The present application belongs to the technical field of freezing equipment, and particularly relates to a horizontal intelligent vending freezer and goods identification method therefor.

### BACKGROUND ART

In the prior art, the automated vending function mostly relies on image collection technology, this mainly involves that images of goods before and after a goods transaction in the freezer are collected by an image collection device, the collected images are sent to a back-end server, the transaction object (including the type and quantity of the goods) is identified by an image processing technology, a transaction order is generated, and the transaction is completed.

In a horizontal intelligent vending freezer, a consumer needs to extend a hand from top to bottom into the freezer to select g, causing the image collection device to be easily blocked by the hand, reducing the collection effect thereof, thereby affecting the generation efficiency of the transaction order and lowering the user experience of the consumer.

### SUMMARY OF THE INVENTION

To address at least one deficiency existing in the prior art, the present application provides a horizontal intelligent vending freezer and a goods identification method therefor.

A first aspect of the present application provides a horizontal intelligent vending freezer, comprising:
a freezer body, provided with an accommodating chamber therein, the accommodating chamber being configured to place goods to be sold;
a visual identification device, configured to collect image information of vending processes, disposed in the accommodating chamber and connected with an inner wall of the freezer body;
gravity sensors, configured to monitor weight change information of the goods in the freezer body before and after sale, and arranged at the freezer body;
a controller, connected with the visual identification device and the gravity sensors; the controller stores types of the goods to be sold and corresponding weight information for each type of goods, and is configured to determine a type and quantity of sold goods based on the weight change information of the goods in the freezer body before and after sale monitored by the gravity sensors and the image information of the vending process collected by the visual identification device, and combined with the stored types of goods and the corresponding weight information for each type of goods.

A second aspect of the present application provides a goods identification method for the horizontal intelligent vending freezer according to the first aspect, comprising the following steps:
S1, determining possible combinations of types and quantities of sold goods by the controller, based on the weight change information of the goods in the freezer body before and after sale monitored by the gravity sensors, and combined with the types of goods and the corresponding weight information for each type of goods stored in the controller;
S2, if there is only one combination, outputting the type and quantity of the sold goods under the combination as an identification result by the controller; if there are multiple possible combinations, by the controller, comparing the multiple possible combinations with the image information of the vending process collected by the visual identification device, and outputting one combination that is consistent with the image information of the vending process collected by the visual identification device as the identification result.

Compared with the prior art, the beneficial effects of the present application are as followings.
(1) According to the horizontal intelligent vending freezer provided in the present application, the weight change information of goods in the freezer body before and after sale is monitored the gravity sensors, a vending process of goods selection is monitored and information collected by the visual identification device, the types of goods and the corresponding weight information for each type of goods stored in the controller are combined, so that type and quantity of sold goods is determined; thereby avoiding the occlusion problem in a used single visual identification mode, improving the accuracy and recognition efficiency of goods identification, and at the same time preventing the goods from being replaced by equal weight, and having high transaction safety and reliability;
(2) In the goods identification method for the horizontal intelligent vending freezer provided in the present application, firstly, possible combination schemes of types and quantities of sold goods are determined by means of a weight-sensing identification result, in combination with the stored the types of goods and the corresponding weight information for each type of goods; when there are multiple possible combination schemes, a final determination is performed in combination with the visual identification result, thereby effectively reducing the visual comparison quantity and having a high identification efficiency, and being capable of achieving rapid goods identification and meeting unmanned vending requirements.

### BRIEF DESCRIPTION OF THE DRAWINGS

FIG. 1 is a first structural schematic diagram of the of a horizontal intelligent vending freezer according to an embodiment of the present application;

FIG. 2 is a second structural schematic diagram of the horizontal intelligent vending freezer;

FIG. 3 is a partial enlarged view of part A in FIG. 2;

FIG. 4 is an assembly method schematic diagram of baskets and gravity sensors of the horizontal intelligent vending freezer in the freezer body;

FIG. 5 is a schematic diagram showing only the baskets and gravity sensors at the bottom thereof in FIG. 4;

FIG. 6 is another assembly method schematic diagram of baskets and gravity sensors of the horizontal intelligent vending freezer in the freezer body;

FIG. 7 is a schematic diagram of a location of a visual identification device in a horizontal intelligent vending freezer;

FIG. 8 is a schematic diagram of the gravity sensors installed on a bottom support frame of a horizontal intelligent vending freezer;

FIG. 9 is a schematic diagram of a connection between a wheel and the gravity sensor in the horizontal intelligent vending freezer;

FIG. 10 is a structural schematic diagram of the wheel in the horizontal intelligent vending freezer in an embodiment;

FIG. 11 is a structural schematic diagram of the wheel in the horizontal intelligent vending freezer in another embodiment;

FIG. 12 is a partial enlarged view of a bottom of the horizontal intelligent vending freezer;

FIG. 13 is a block diagram of a controller, visual identification device, gravity sensors, and defrosting system in the horizontal intelligent vending freezer;

FIG. 14 is a schematic diagram of a connection between a signal processing board, the gravity sensors, and the controller;

FIG. 15 shows a schematic diagram of the basket in the horizontal intelligent vending freezer;

FIG. 16 is a partial enlarged view of part B in FIG. 15;

FIG. 17 is a partial enlarged view of part C in FIG. 15;

FIG. 18 is a partial enlarged view of part D in FIG. 15;

FIG. 19 is a schematic diagram of a front plate and side plate connected by a rotating member;

FIG. 20 is a schematic diagram of a transverse partition;

FIG. 21 is a structural schematic diagram of a horizontal intelligent vending freezer provided in one embodiment of the present application;

FIG. 22 is a partial enlarged view of part E in FIG. 21;

FIG. 23 is a schematic diagram of the horizontal intelligent vending freezer equipped with a face recognition screen;

FIG. 24 is a schematic diagram of an external device;

FIG. 25 is a partial enlarged view of part F in FIG. 24.

FIG. 26 is a partial enlarged view of part G in FIG. 24;

FIG. 27 is a structural schematic diagram of a connecting component in an embodiment of the present application;

FIG. 28 is a structural schematic diagram of a first connector;

FIG. 29 is a structural schematic diagram of a second connector;

FIG. 30 is a flowchart of a goods identification method provided in an embodiment of the present application;

FIG. 31 is a flowchart of step S1 in the goods identification method;

FIG. 32 is a flowchart of a process of a master control unit receiving weight data after curve fitting in the goods identification method provided in an embodiment of the present application;

FIG. 33 is a flowchart of a process of the master control unit analyzing and recording the received weight data in the goods identification method.

### DETAILED DESCRIPTION OF THE EMBODIMENTS

The technical solutions in the embodiments of the present application will be clearly and completely described below with reference to the accompanying drawings. Obviously, the described embodiments are only a part of the embodiments of the present application, and not all of them. All other embodiments obtained by those skilled in the art based on the embodiments of the present application without creative effort are within the scope of protection of the present application.

In the description of the application, it should be understood that the terms “center,” “transverse,” “longitudinal,” “upper,” “lower,” “front,” “rear,” “back,” “left,” “right,” “vertical,” “horizontal,” “top,” “bottom,” “inner,” and “outer,” etc., indicate the orientation or positional relationship based on the orientation or positional relationship shown in the accompanying drawings, and are only for the convenience of describing the application and simplifying the description, and do not indicate or imply that the device or element referred to must have a specific orientation, or be constructed and operated in a specific orientation, and therefore should not be construed as a limitation of the present application.

The terms “first” and “second” are used for descriptive purposes only and should not be construed as indicating or implying relative importance or implicitly specifying the number of indicated technical features. In the description of the application, it should be noted that, unless otherwise explicitly specified and limited, the terms “installation,” “mounting,” “connect,” “connecting” and “connected” should be interpreted broadly. For example, they can refer to a fixed connection, a detachable connection, or an integral connection; they can refer to a direct connection or an indirect connection through an intermediate medium; and they can refer to the internal connection of two components. Those skilled in the art can understand the specific meaning of the above terms in the application based on the specific circumstances.

The term “multiple” in the present application refers to two or more. “And/or” describes the relationship between related objects, indicating that three relationships can exist; for example, “A and/or B” can represent: A existing alone, A and B existing simultaneously, and B existing alone. The character “/” generally indicates that the preceding and following related objects are in an “or” relationship.

A first embodiment of the present application provides a horizontal intelligent vending freezer, as shown in FIGS. 1-7. In an illustrative embodiment, the horizontal intelligent vending freezer includes a freezer body 11, a visual identification device 2, gravity sensors 3, and a controller 4. An accommodating chamber 111 is formed within the freezer body 11 for placing goods to be sold. The visual identification device 2, located within the accommodating chamber 111 and connected to an inner wall 114 of the freezer body 114, is configured to collect image information of vending processes.

The gravity sensors 3, located at the freezer body 11, is configured to monitor weight change information of the goods in the freezer body 11 before and after sale. The controller 4 is connected with the visual identification device 2 and the gravity sensors 3, and stores types of goods to be sold and corresponding weight information for each type of goods, and is configured to determine the type and quantity of sold goods based on the weight change information of the goods in the freezer body 11 before and after sale monitored by the gravity sensors 3, and the image information of the vending process collected by the visual identification device 2, combined with the stored types of goods and corresponding weight information for each type of goods.

In the aforementioned horizontal intelligent vending freezer, the weight change information of the goods in the freezer body before and after sale is monitored by the gravity sensors, and the vending process of consumers selecting goods is monitored and information is collected by the visual identification devices, the stored types of goods and corresponding weight information for each type of goods stored in the controller is further combined, thus, the type and quantity of sold goods are determined; which avoids obstruction problems inherent in relying solely on visual identification, improving the accuracy and efficiency of product identification. At the same time, the visual identification device monitors both the goods inside the freezer body and the consumer's transaction process, preventing goods from being replaced with items of equal weight, ensuring high transaction security and reliability.

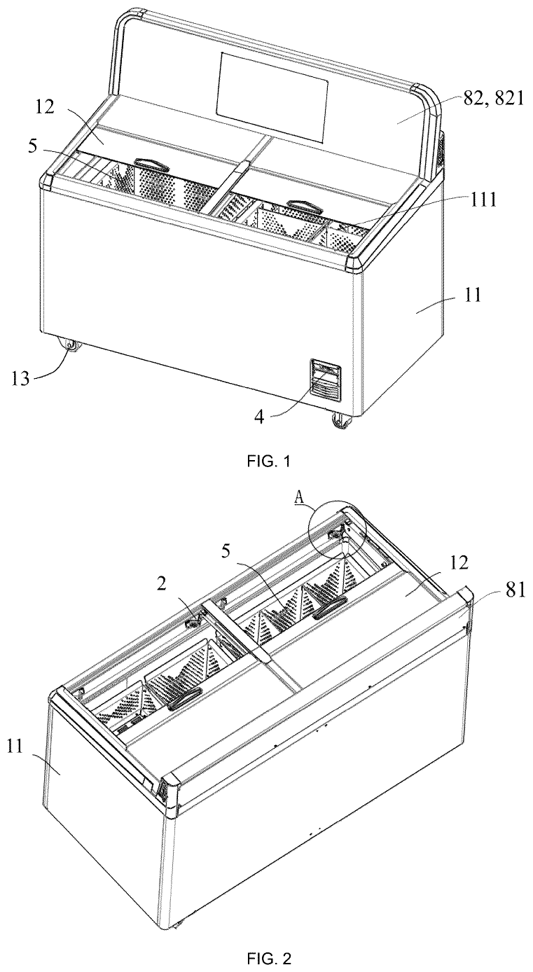

A top of the freezer body 11 is provided with a door body 12 for opening or closing the accommodating chamber 111. There might be multiple door bodies 12, and the accommodating chamber 111 is divided into multiple storage areas corresponding to each door body 12. Each door body 12 can be opened or closed individually for one of the corresponding storage areas. The horizontal intelligent vending freezer provided in this embodiment, as shown in FIGS. 1 and 2, has two door bodies 12. The accommodating chamber 111 within the freezer body 11 is divided into a first storage area and a second storage area corresponding to the two door bodies 12. The door bodies 12 corresponding to the first and second storage areas operate independently, allowing each storage area to be opened or closed separately.

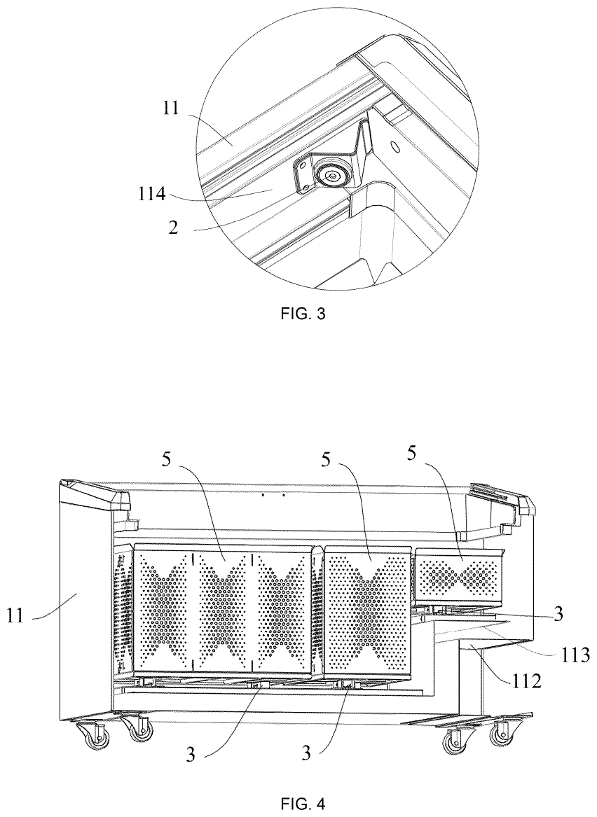

As shown in FIG. 3, a visual identification device 2 is disposed within the accommodating chamber 111 and connected to the inner wall of the freezer body 112. On one hand, the visual identification device 2 can collect images of the transaction process by image identification technology; on the other hand, it can monitor the goods in the accommodating chamber 111, preventing the goods from being replaced by other objects of equal weight, thus increasing the safety of the goods. It should be noted that the image information collected by the visual identification device 2 includes pictures and/or videos of a consumer selecting goods. The information collected by a visual identification device and the identification of the traded goods using the visual identification device are prior art and will not be elaborated here.

In some embodiments, the visual identification device 2 includes multiple cameras 21 disposed on the inner wall of the accommodating chamber 111, used to capture image information of the goods before and after sale. For example, at least two cameras in each storage area capture image information of the goods inside this storage area from different angles, so that the problem that image information of the vending process cannot be collected due to being blocked when only one camera is provided can be avoided, and the recognition accuracy of the goods is ensured. It should be noted that an installation height of the visual identification device 2 should be higher than a height of the goods placed inside the accommodating chamber 111 to prevent the goods from obstructing the visual identification device 2.

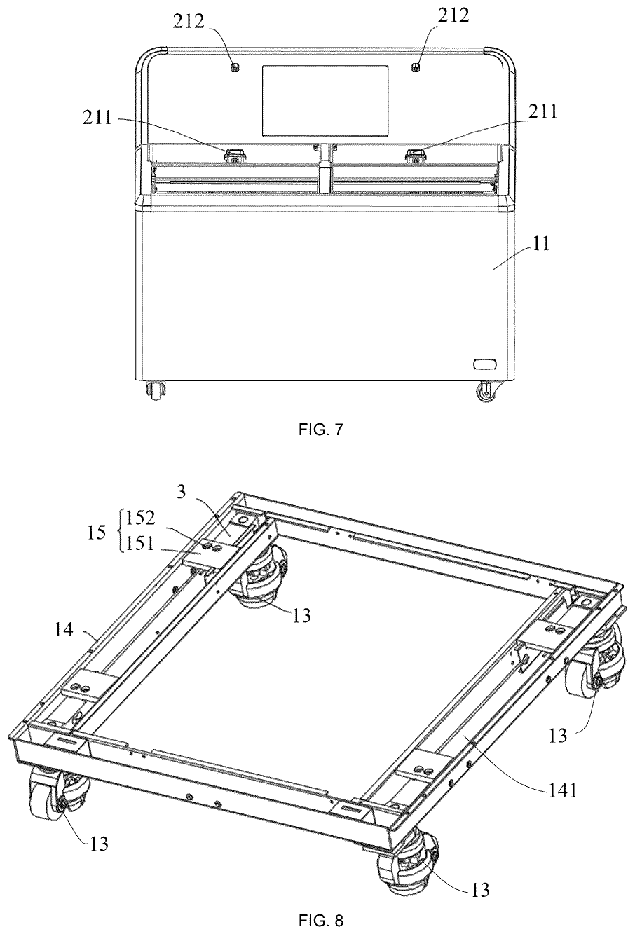

In some embodiments, as shown in FIG. 7, the visual identification device 2 includes a first camera 211 and a second camera 212; the first camera 211 is disposed on the inner wall of the accommodating chamber 111 and is used to capture image information of the goods before and after sale; the second camera 212 is disposed outside the accommodating chamber 111 and is used to capture image information of the vending processes from above. At least one first camera 211 and one second camera 212 are provided. By providing cameras 21 inside and outside the freezer body 11, comprehensive image information of the vending process can be obtained.

The gravity sensors 3 can be installed inside or outside the freezer body 11 as needed. The following provides two installation methods of the gravity sensors 3 located inside and outside the freezer body 11 respectively.

In a first installation method, the gravity sensors 3 are installed inside the freezer body 11.

The freezer body 11 typically contains a compressor room 112, which houses equipment such as a compressor, etc. A step shape 113 is formed within the accommodating chamber 111 corresponding to the compressor room 112. The compressor room 112 occupies some space in the freezer body 11.

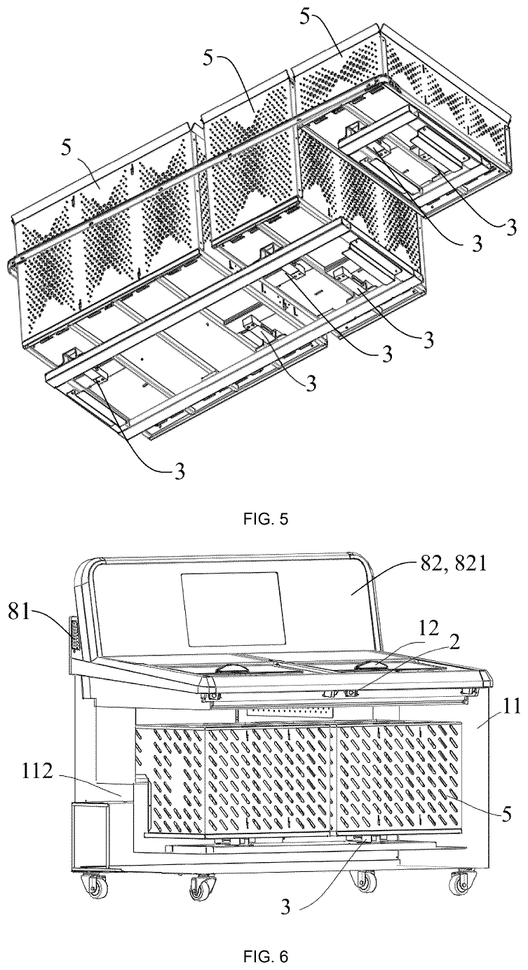

In some embodiments, as shown in FIGS. 4 and 5, the compressor room 112 is located adjacent to a left or right side of the freezer body 11. Multiple baskets 5 for placing goods are provided within the accommodating chamber 111; the multiple baskets 5 are arranged side-by-side along the left-right direction of the freezer body 11. At least one basket 5 is located on the step shape 113. At least one gravity sensor 3 is correspondingly provided between each basket 5 and a bottom wall of the accommodating chamber 111. The gravity sensor 3 is used to collect weight change information of the corresponding basket 5 and the goods therein.

In the above embodiments, it is understood that if a basket with a step-shaped bottom is placed within the accommodating chamber 111, spanning both on and off the step shape, the gravity center of the basket will change depending on the placement of the goods; if there are more goods above the compressor room 112, the gravity center of the basket may be above the compressor room 112; if there are fewer goods above the compressor room 112, the gravity center of the basket may be biased away from the compressor room 112, leading to inaccurate detection results from the gravity sensors 3. Therefore, in the present embodiment, the multiple baskets 5 are arranged side-by-side along the left-right direction of the freezer body 11, wherein at least one basket 5 is located above the step shape formed by the compressor room 112. That is, a bottom surface of each basket 5 is flat; the gravity sensor 3 is correspondingly installed for each basket 5, ensuring the accuracy of weight detection. It should also be noted that, as shown in FIG. 5, each basket 5 is equipped with two gravity sensors 3, which are arranged along an oblique line in the same horizontal plane to improve the detection accuracy of the gravity sensors 3. Optionally, the two gravity sensors 3 are correspondingly arranged on a diagonal line at the bottom surface of the basket 5.

In other embodiments, as shown in FIG. 6, the compressor room 112 is located adjacent to a rear side of the freezer body 1, and a rear part of the basket 5 extends onto the step shape 113. The gravity sensors 3 are arranged between a bottom part of the basket 5 in front of the step shape 113 and the bottom wall of the accommodating chamber 111. The gravity sensors 3 are configured to collect weight change information of the basket 5 and the goods therein. Understandably, when the compressor room 112 is positioned near the rear side of the freezer body 11, the width thereof is smaller than the width of the freezer body 11. Only a small part of the basket 5 needs to extend onto the step shape 113, which does not significantly affect the gravity center of the basket 5. With this arrangement, only one basket 5 is arranged in each storage area, reducing the number of gravity sensors 3 required and thus lowering costs.

In a second installation method, the gravity sensors 3 are arranged outside the freezer body 11.

The arrangement of the gravity sensors 3 outside the freezer body 11 avoids the influence of the step shape 113 formed by the compressor room 112 inside the freezer body 11 and prevents the gravity sensors 3 from being affected by frosting inside the freezer body 11. In this arrangement, the horizontal intelligent vending freezer also includes four wheels 13, located at the bottom of the freezer body 11 respectively. There are four gravity sensors 3 installed between the four wheels 13 and the freezer body 11 respectively, to collect weight change information of the horizontal intelligent vending freezer. In this case, the gravity sensors 3 monitor the weight change of the entire vending freezer, not just the weight change of the goods in a single basket 5. Since the gravity sensors 3 are located outside the freezer body 11, the effects of temperature changes and frosting inside the freezer body 11 on the gravity sensors 3 are avoided, extending the service life.

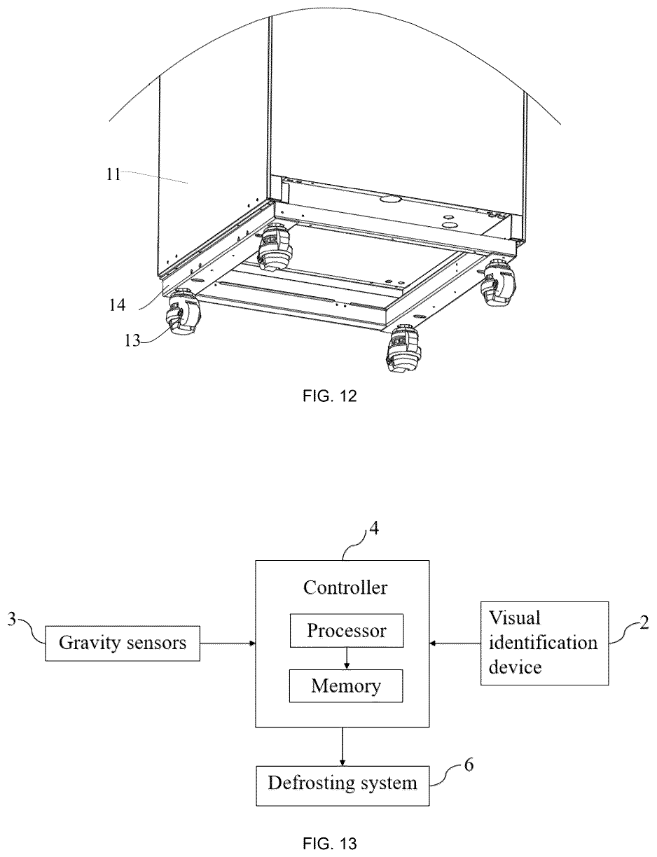

Specifically, as shown in FIGS. 8-12, the horizontal intelligent vending freezer further includes a bottom support frame 14 arranged at the bottom of the freezer body 11 and supporting the freezer body 11. The bottom support frame 14 is connected to the bottom of the freezer body 11, and is internally provided with an accommodating groove 141; the four gravity sensors 3 are respectively provided at four corners of the bottom support frame 14 and are located in the accommodating groove 141. The four gravity sensors 3 are symmetrically arranged, specifically symmetrical with respect to a center line of the bottom support frame 14. The first end 31 of each gravity sensor 3 is connected with the bottom support frame 14, and a lower part of a second end 32 is connected with the wheel 13 to support the bottom support frame 14 on top of the wheel 13. The wheel 13 does not contact with the bottom support frame 14.

The freezer body 11 is connected via the bottom support frame 14, and the first end 31 of the gravity sensor 3 is connected to the bottom support frame 14, thus the gravity sensor 3 and the freezer body 11 are connected together through the bottom support frame 14. Simultaneously, the second end 32 of the gravity sensor 3 is connected to the wheel 13, the wheel 13 and the bottom support frame 14 do not directly contact with each other, ensuring that total weight change of the freezer body 11 and goods therein is transmitted to the gravity sensor 3 entirely through the bottom support frame 14, and enabling the gravity sensor 3 to identify the goods.

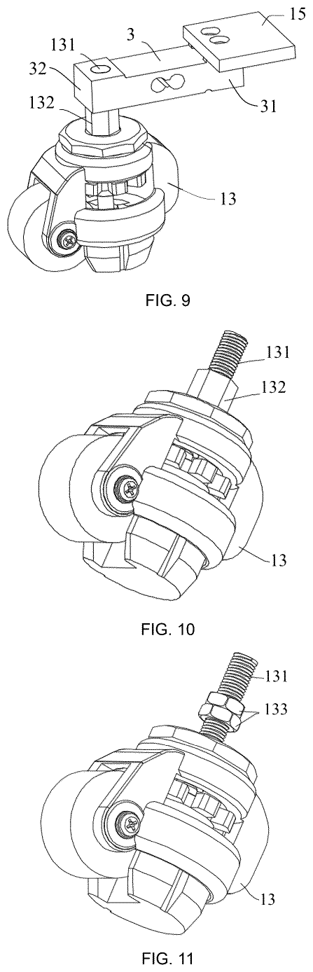

As shown in FIGS. 8 and 9, the first end 31 of the gravity sensor 3 is connected to a top of the bottom support frame 14 via a suspension connector 15, allowing the gravity sensor 3 to be suspended in the accommodating groove 141, thereby ensuring the accuracy of the weight change data collected by the gravity sensor 3. It should be noted that the suspension connector 15 specifically includes a shim plate 151 welded to the top of the bottom support frame 14 and a connecting bolt 152 connecting the shim plate 151 and the first end of the gravity sensor 3. It is understood that those skilled in the art can also use other methods to connect the first end 31 of the gravity sensor 3 to the bottom support frame 14, as long as the accuracy of the weight change data collected by the gravity sensor 3 can be guaranteed.

As shown in FIGS. 8-11, the wheel 13 has a connecting shaft 131 vertically arranged, and the connecting shaft 131 is threadedly connected to the second end 32 of the gravity sensor 3. The connecting shaft 131 facilitates the connection of the wheel 13 to the second end 32 of the gravity sensor 3. It is understood that the bottom of the bottom support frame 14 has a hole for the connecting shaft 131 to pass through, thereby facilitating the installation of the wheel 13.

In some embodiments, as shown in FIG. 10, a limiting step 132 is provided on an outer periphery of the connecting shaft 131. A top of the limiting step 132 abuts against the bottom of the gravity sensor 3, thereby restricting the connection position of the gravity sensor 3 on the connecting shaft 131 to a position where the top of the connecting shaft 131 does not protrude beyond the top of the gravity sensor 3. A portion of the connecting shaft 131 above the limiting step 132 has an external thread for connecting the gravity sensor 3. This arrangement prevents the top of the connecting shaft 131 from contacting the top of the bottom support frame 14, thus avoiding direct contact between the wheel 13 and the bottom support frame 14.

In other embodiments, as shown in FIG. 11, the connecting shaft 131 is threadedly connected with a locking nut 133. A top of the locking nut 133 abuts against the bottom of the gravity sensor 3 to lock and adjust a connection position of the gravity sensor 3 on the connecting shaft 131. By adjusting a depth of the connecting shaft 131 screwed into the second end 32 of the gravity sensor 3, the connection position of the gravity sensor 3 on the connecting shaft 131 can be adjusted, thereby facilitating the adjustment of lever of the gravity sensor 3 with the ground and meeting the horizontal working environment required by the gravity sensor 3. Once the connection position of the gravity sensor 3 is adjusted in place, the locking nut 133 is screwed to cause the locking nut 133 to abut against the bottom of the gravity sensor 3, so that the connection position of the gravity sensor 3 on the connecting shaft 131 is locked, preventing displacement of the gravity sensor 3. It should be noted that, to ensure the locking effect, the present embodiment adopts two locking nuts 133 arranged up and down.

The above describes specific implementations of the gravity sensor 3 located inside and outside the freezer body 11. Those skilled in the art can adjust these implementations according to actual needs. When located inside the freezer body 11, the gravity sensors 3 obtains the weight change of the goods inside the basket 5 by monitoring the weight change of the basket 5. When located outside the freezer body 11, the gravity sensor 3 is positioned at the four corners of the bottom of the freezer body 11, and obtains the weight change of the goods inside the freezer body 11 by monitoring the weight change of the entire freezer body 11.

When the gravity sensors 3 are placed inside the freezer body 11 adopting the first installation method described above, frost may form inside the freezer body 11; to prevent frost from adversely affecting the gravity sensors 3, as shown in FIG. 13, the horizontal intelligent vending freezer also includes a defrosting system 6, which is used to defrost the accommodating chamber 111 when frost forms, and which is located inside the freezer body 11. The visual identification device 2 is also used to collect images of the inner wall of the accommodating chamber 111. The controller 4 is connected with the defrosting system 6 and is configured to control the defrosting system 6 to defrost when the visual identification device 2 collects image information of frost forming on the inner wall of the accommodating chamber 111.

The controller 4 controls the defrosting system 6 to perform defrosting in time when the accommodating chamber 111 is frosting, thereby avoiding the influence of frosting on the identification accuracy of the gravity sensors 3 in the freezer body, ensuring the accuracy of weight-sensing identification, and improving the reliability of goods identification. It should be noted that the defrosting system 6 is a conventional configuration of a horizontal freezer, and is well known to a person skilled in the art, and the specific structure thereof is not repeated here. It also should be noted that the horizontal intelligent vending freezer provided in the present embodiment is further provided with a conventional periodic defrosting procedure to control the defrosting system 6 to perform periodic defrosting.

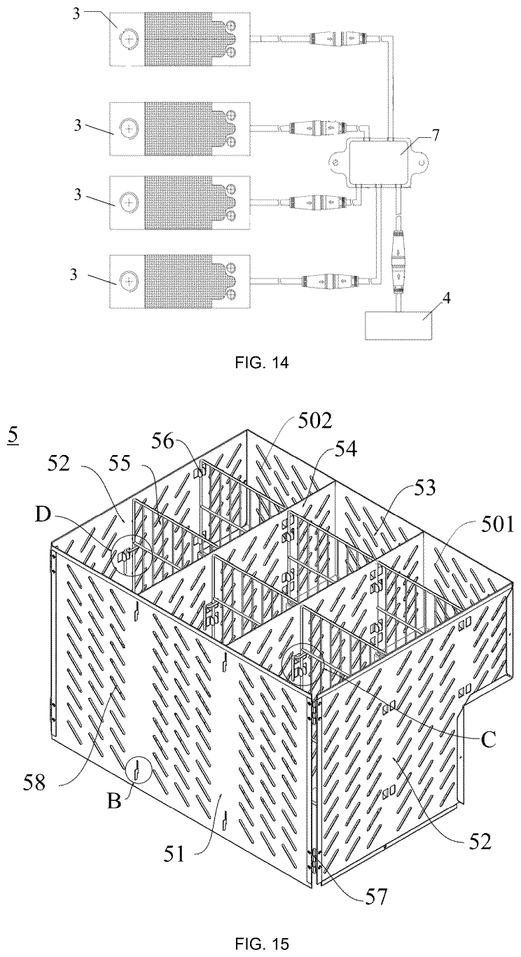

When the gravity sensors 3 are placed outside the freezer body 11 adopting the second installation method described above, in order to identify goods based on weight changes, the horizontal intelligent vending freezer further includes a signal processing board 7; as shown in FIG. 14, the signal processing board 7 is in communication connection with the four gravity sensors 3 respectively, and is used to perform curve fitting for the total weight change data collected by the four gravity sensors 3 in real time, and output the weight data after curve fitting in real time. The controller 4 is in communication connection with the signal processing board 7, and the controller 4 includes a memory 41 and a processor 42. The memory 41 is used to store the weight data output by the signal processing board 7; and the processor 42 is configured to calculate, according to a preset time interval, a mean value and a standard deviation of all weight data stored in this time interval; if the calculated standard deviation is less than a preset deviation, the calculated mean value of the weight data is taken as the weight-sensing value of this time interval and recorded in the memory; if the calculated standard deviation is greater than or equal to the preset deviation, the weight data within this time interval is discarded. When the door body is opened, multiple weight-sensing values recorded from a previous closing to the current opening of the door body are retrieved from the memory 41 to determine a weight before opening; after the door body is closed, multiple weight-sensing values recorded after current closing of the door body are retrieved from the memory 41 to determine a weight after closing; and a difference between the weight before opening and the weight after closing is used to determine the goods currently been sold.

In the above embodiment, when the controller 4 receives the weight data after curve fitting, the data within the time period with a large deviation during continuous data collection is discarded to avoid inaccurate data collection caused by external contact with the gravity sensors 3, ensuring the accuracy of goods identification. The signal processing board 7 acquires analog signals from the four gravity sensors 3 and performs curve fitting for four-way data, converting the analog signals into digital signals and transmitting to the controller 4 via RS485 communication. Curve fitting of data via a signal processing board 7 is a conventional technique in the field, similar to the curve fitting data process of a gravity sensor with dual-weight-sensing curve fitting, and will not be described in detail here.

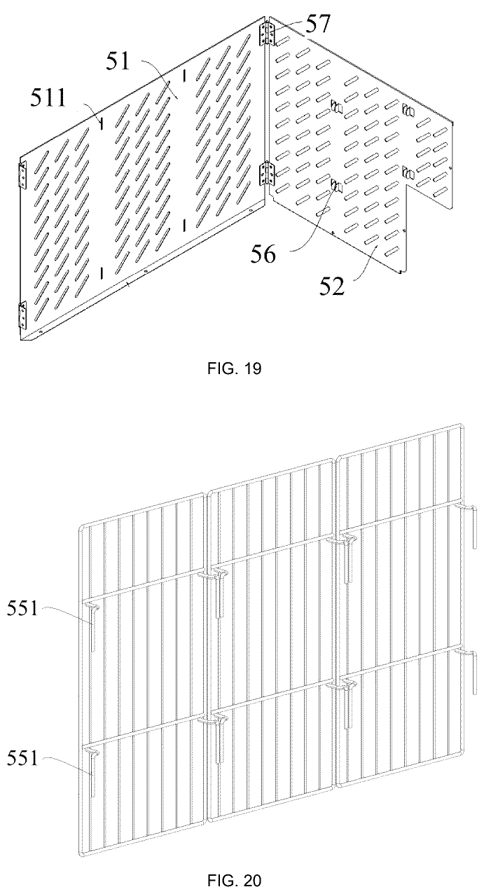

In some embodiments, the accommodating chamber 111 of the horizontal intelligent vending freezer is internally provided with one or more baskets 5 for placing goods, and the basket 5 is a detachable foldable basket. As an implementation of the detachable foldable basket, as shown in FIGS. 15-20, the basket 5 includes a front plate 51, two side plates 52 and a rear plate 53; the two side plates 52 are correspondingly disposed on two opposite sides of the front plate 51, and the side plates 52 are rotatably connected with the front plate 51, so that the side plates 52 are able to be folded with the front plate 51; the rear plate 53 is disposed opposite to the front plate 51 in horizontal direction; two opposite sides of the rear plate 53 are correspondingly connected with the two side plates 52; and the rear plate 53, the front plate 51 and the two side plates 52 together define a storage chamber 501 for placing goods, and a top of the storage chamber is provided with a storage chamber opening for placing goods in the storage chamber or taking goods out of the storage chamber. The front plate 51, rear plate 53, and side plates 52 are respectively provided with ventilation holes 58 to allow air to circulate inside and outside the storage chamber 501, facilitating heat exchange for the goods within the storage chamber 501.

An end of the front plate 51 connected with the side plate 52 is connected with a rotating member 57; and the front plate 51 is rotatably connected with the side plate 52 via the rotating member 57. By using the rotating member 57 to connect the front plate 51 and the side plate 52, the rotating member 57 bears the connection stress between the front plate 51 and the side plate 52, preventing damage to either the front plate 51 or the side plate 52 due to direct rotational connection. When it is damaged, only the rotating member 57 needs to be replaced, without needing to replace the side plate 52 and/or the front plate 51, reducing maintenance and replacement costs. The rotating member 57 can be a hinge or similar member.

The rear plate 53 is connected with a fastener, and the side plate 52 is detachably connected with the rear plate 53 via the fastener. The rear plate 53 constrains the side plates 52 to prevent them from moving, thus preventing the front plate 51 and side plates 52 from folding together and increasing the overall strength of the basket 5. When the two side plates 52 are constrained by the rear plate 53 and cannot move, the two side plates 52 also constrain the left and right sides of the front plate 51, thereby preventing the front plate 51 from moving and thus preventing the front plate 51 and side plates 52 from folding together. The fastener can be a component such as a bolt or a screw.

In some embodiments, the basket 5 also includes at least one vertical partition 54, disposed within the storage chamber 501 and dividing the storage chamber 501 into at least two parallel storage areas 502. The vertical partition 54 and the two side plates 52 are arranged opposite to each other in the horizontal direction, and front and rear ends of the vertical partition 54 are connected with the front plate 51 and the rear plate 53 respectively. Optionally, each of the vertical partitions 54 is provided with ventilation holes 58 to allow air circulation between the storage areas.

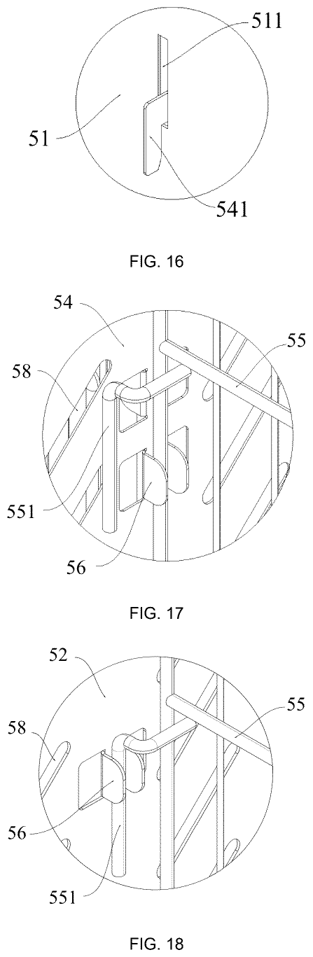

To facilitate the installation of the vertical partition 54, as shown in FIGS. 15 and 16, an end of the vertical partition 54 facing the front plate 51 is provided with a hook 541. The front plate 51 is provided with a connection port 511, which corresponds to the hook 541. The hook 541 passes through the connection port 511 and engages with an outer edge of the connection port 511, to connect the vertical partition 54 with the front plate 51. An end of the vertical partition 54 facing the rear plate 53 is connected with a fastener, and is detachably connected with the rear plate 53 via the fastener.

To further divide the storage chamber and facilitate consumer's selection, in some embodiments, as shown in FIGS. 15, 17 and 18, the basket further includes a transverse partition 55, disposed in the storage area 502 and intersected with the side plate 52 and the vertical partition 54, to divide the same storage area 502 into at least two sections. The transverse partition 55 is arranged opposite to the front plate 51 in the horizontal direction; one end of the transverse partition 55 is connected with the vertical partition 54 and the other end thereof is connected with either the vertical partition 54 or the side plate 52. Optionally, the transverse partition 55 is a hollow frame structure to allow air circulation within the same storage area.

To facilitate the mounting of the transverse partition 55, as shown in FIGS. 17 and 18, a clamping part 56 is provided on the side plate 52 and the vertical partition 54 respectively; the clamping part 56 is located on a side of the side plate 52 facing the storage chamber 501 or a side of the vertical partition 54 connecting to the transverse partition 55. The transverse partition 55 is connected with the side plate 52 or the vertical partition 54 via the clamping part 56. Optionally, the clamping part 56 is formed by bending a metal sheet provided on the vertical partition 54.

As shown in FIGS. 18 and 20, the transverse partition 55 is provided with a connecting part 551, located within the storage area 502 and provided at an end of the transverse partition 55 connecting with the side plate 52 or vertical partition 54; the connecting part 551 is connected with the clamping part 56, to connect the transverse partition 55 with the vertical partition 54 and/or the side plate 52. The connecting part 551 and a side edge of the transverse partition 55 are arranged at intervals in a direction parallel to the side plate 52. The partition plate 55 is able to connect to the clamping part 56 by the side edge or by the connecting part 551, so that the transverse partition 55 has at least two adjustable installation positions.

The installation steps of the above-mentioned detachable foldable basket are as follows: the side plates 52 and the front plate 51 are at a right angle, and the end of the side plates 52 away from the front plate 51 are connected to the rear plate 53 by fasteners, so that the side plates 52, the front plate 51 and the rear plate 53 are connected together to define the storage chamber 501; the vertical partition 54 is then placed inside the storage chamber 501, the hook 541 of the vertical partition 54 passes through the connection port 511 and located at the outer edge of the storage chamber 501, so that the hook 541 is matched with the outer edge of the connection port 511; the vertical partition 54 is then fixedly connected with the rear plate 53 by fasteners to secure it; and finally, the transverse partition 55 is installed inside the storage area 502, connected to the vertical partition 54 or the side plate 52 via the clamping part 56 to secure it.

When the basket 5 needs to be transported, the transverse partition 55 and vertical partition 54 are disassembled, so are the side plates 52 and the rear plate 53; the front plate 51 and the side plates 52 are then folded together to reduce the space occupied by the basket 5 and facilitate transportation. When a component of the basket 5 is damaged, the basket 5 is disassembled to replace or repair only the damaged component.

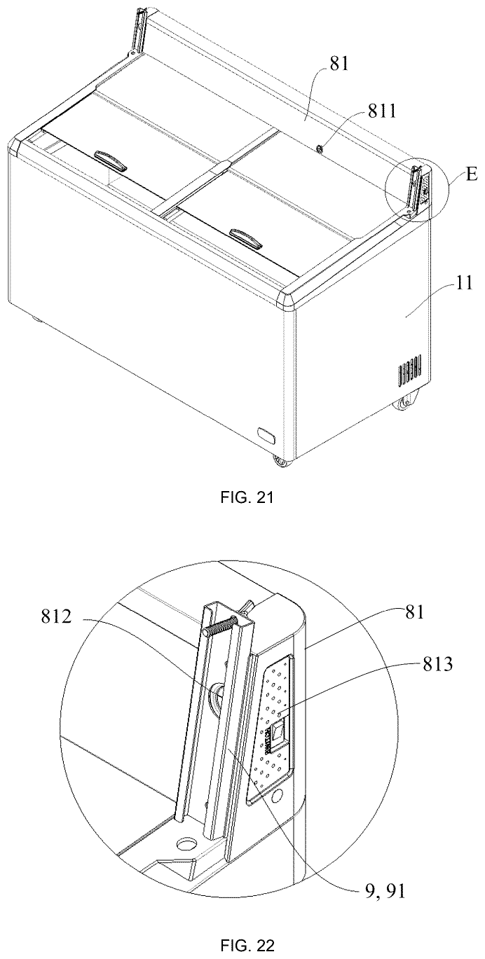

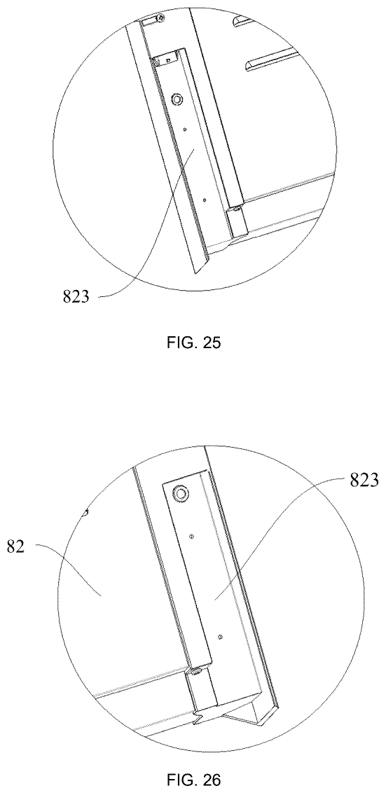

In some embodiments, as shown in FIGS. 21-29, the horizontal intelligent vending freezer further includes a master control box 81, an external device 82, and a connecting component 9. The master control box 81 is connected with the freezer body 11, has a first wiring hole 811 and a second wiring hole 812; an electrical device 813 is housed within the master control box 81. The electrical device 813 includes components such as a controller, a power supply etc. The electrical device 813 is configured to provide power to the external device 82 and/or control the operation of the external device. The electrical device 813 is prior art and will not be described in detail further. The connecting component 9 is connected with the master control box 81; the external device 82 is connected with the connecting component 9, allowing for a detachable connection between the external device 82 and the master control box 81. Wires connecting different types of the external device 82 are connected to the electrical device 813 through the first wiring hole 811 or the second wiring hole 812.

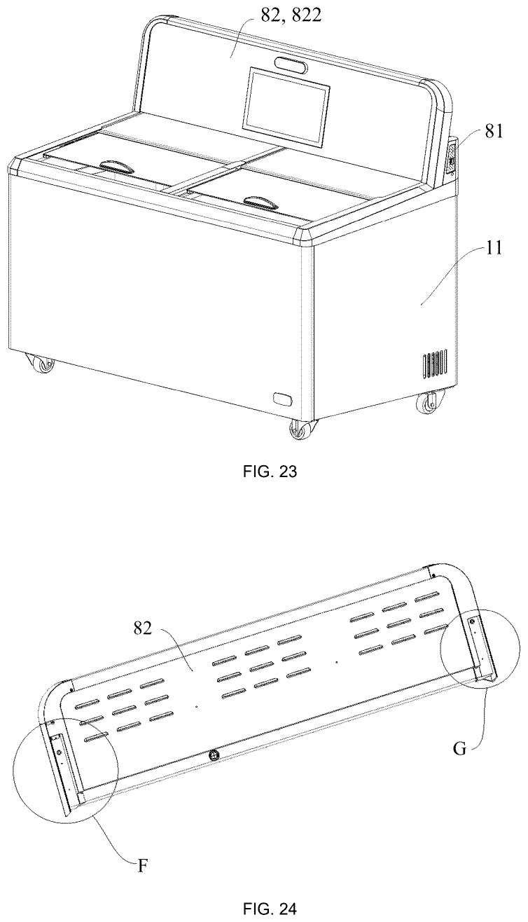

The external device 82 can be an advertising machine 821 (see FIG. 1) or a payment processing device. The advertising machine 821 is configured for advertising and content display, while the payment processing device is configured to identify information about consumers and/or goods and to settle goods-related fees. The payment processing device can be a face recognition screen 822 (see FIG. 23) or a panel with a POS terminal. A wire connecting with the advertising machine 821 is connected to the electrical device 813 through the first wiring hole 811; a wire connecting with the payment processing device is connected to the electrical device 813 through the second wiring hole 812.

The external device 82 is connected with the master control box 81 by the connecting component 9, allowing for a detachable connection between the external device 82 and the freezer body 11. This facilitates the transportation of the vending freezer and the maintenance and replacement of the external device; thus the freezer body 11 can be connected to either the advertising machine or the payment processing device, and both are connected to the freezer body 11 via the connecting component 9, enabling interchangeability and increasing the applicability.

As shown in FIGS. 24-26, a side of the external device 82 facing the master control box 81 is provided with a mounting groove 823. When the external device 82 is connected with the master control box 81 via the connecting component 9, the connecting component 9 is positioned in the mounting groove 823, allowing the side of the external device 82 with the mounting groove 823 to form surface contact with the master control box 81. The master control box 81 is located at the top of the freezer body 11, and the external device 82 is also located at the top of the freezer body 11. A side of the master control box 81 facing the external device 82 is an inclined surface, and the external device 82 is arranged obliquely along the inclined surface, thus providing support for the external device 82 from the master control box 81.

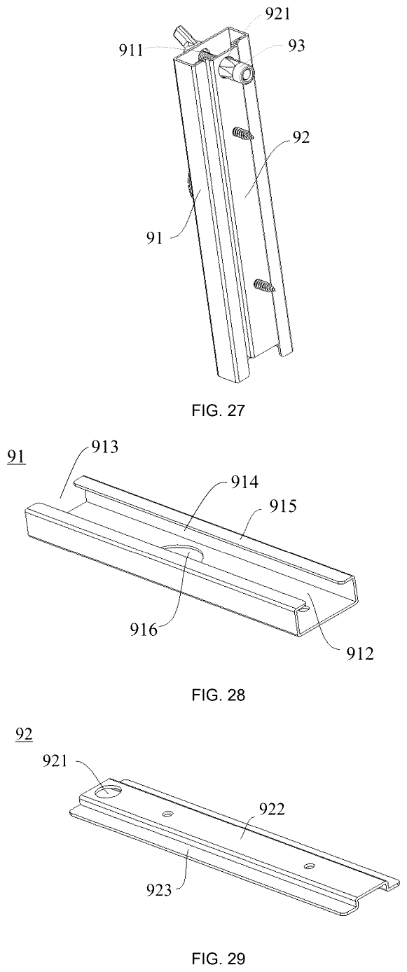

As shown in FIG. 27, the connecting component 9 includes a first connector 91 and a second connector 92; the first connector 91 is connected with the master control box 81; and the second connector 92 is connected with the external device 82 and is detachably connected with the first connector 91. It should be noted that during actual assembly of the freezer body 11 and the external device 82, firstly the second connector 92 is connected with the external device 82, the first connector 91 is connected with the master control box 81, and then the second connector 92 is connected with the first connector 91; this achieves the connection between the external device 82 and the master control box 81, enabling the installation of the external device 82 on the freezer body 11.

To facilitate the detachable connection between the first connector 91 and the second connector 92, further referring to FIG. 27, the first connector 91 has a first connecting hole 911, and the second connector 92 has a second connecting hole 921 corresponding to the first connecting hole 911. When the first and second connecting holes 911, 921 are aligned with each other, the same fastener 93 is disposed in both the first and second connecting holes 911, 921, to make the first connector and the second connector connected. The fastener 93 can be a bolt or screw, etc., are common technical means in the field and will not be described in detail further.

As shown in FIG. 28, the first connector 91 has a mounting chamber 912. A top of the first connector 91 forms a mounting port 913, and the first connector 91 has a mounting chamber opening 914 facing the external device. The mounting port 913 opens the top of the mounting chamber 912, and the mounting chamber opening 914 opens a side of the mounting chamber 912 facing the external device 82. Two limiting parts 915 are provided on two opposite sides of the mounting chamber opening 914, extending along the inclined surface of the master control box 81. As shown in FIG. 29, the second connector 92 includes a protrusion part 922 and two extension parts 923 provided at two sides of the protrusion part 922. The protrusion part 922 is formed by protruding from a middle portion of the second connector 92 towards the external device 82, and the two extension parts 923 extend along the inclined surface of the master control box 81. The extension parts 923 of the second connector 92 are inserted into the mounting chamber 912 of the first connector 91 through the mounting port 913, and the protrusion part 922 closes the mounting chamber opening 914. The extension parts 923 contact with sides of the limiting parts 915 facing the mounting chamber 912 to prevent the second connector 92 from detaching from the first connector 91 through the mounting chamber opening 914.

For convenient wiring, a through hole 916 is formed on the first connector 31, communicating with the mounting chamber 912. The installed second connector 92 and an inner wall of the mounting chamber 912 with the through hole 916 are opposite arranged and spaced apart, to jointly define a wiring channel; and the mounting port 913 is an outlet end of the wiring channel.

It should be noted that, there are usually configured two connectors 9, located at two ends of the external device 82 in the longitudinal direction, to increase the strength and reliability of the connection between the external device 82 and the freezer body 11. Correspondingly, the external device 82 is provided with two mounting grooves 823, and the two connecting components 9 are arranged in the two mounting grooves 823, to increase the strength of the connection between the external device 82 and the master control box 81. It also should be noted that the two connecting components 9 have the same structure so that they can be interchanged, and the types thereof 9 can be reduced, which facilitates the storage and use.

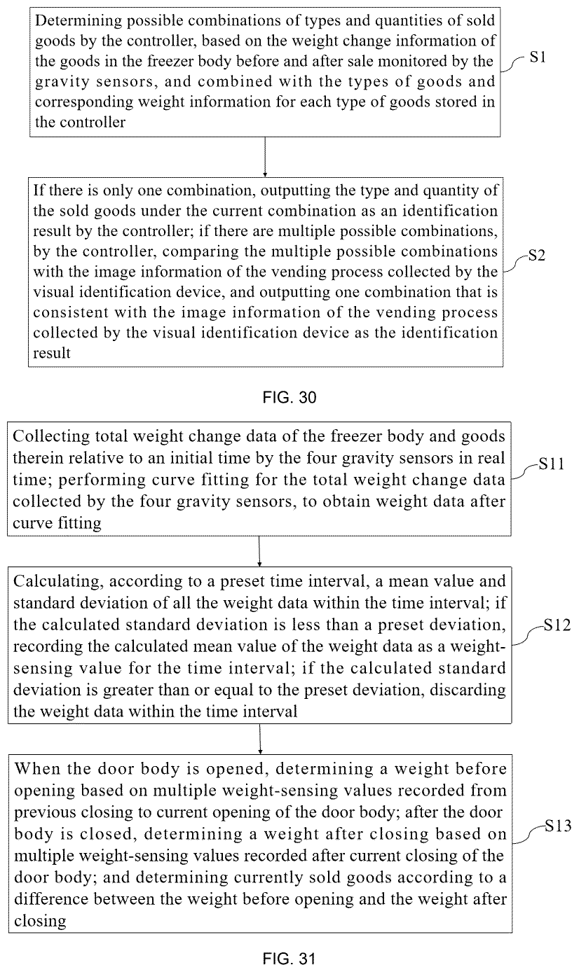

A second embodiment of the present application provides a goods identification method for the horizontal intelligent vending freezer according to any of the above embodiments. As shown in FIG. 30, in an illustrative embodiment of the goods identification method of the present application, including the following steps:
S1, determining possible combinations of types and quantities of sold goods by the controller 4, based on the weight change information of the goods in the freezer body 11 before and after sale monitored by the gravity sensors 3, and combined with the types of goods and corresponding weight information for each type of goods stored in the controller 4;
S2, if there is only one combination, outputting the type and quantity of the sold goods under the current combination as an identification result by the controller 4; if there are multiple possible combinations, by the controller 4, comparing the multiple possible combinations with the image information of the vending process collected by the visual identification device 2, and outputting one combination that is consistent with the image information of the vending process collected by the visual identification device 2 as the identification result.

When the gravity sensors 3 are placed outside the freezer body 11 adopting the second installation method above, as shown in FIG. 31, the step S1 specifically includes the following steps:
S11, Collecting total weight change data of the freezer body 11 and goods therein relative to an initial time by the four gravity sensors 3 in real time; performing curve fitting for the total weight change data collected by the four gravity sensors 3, to obtain weight data after curve fitting. The weight change data detected by the gravity sensors 3 is converted to a digital signal through the curve fitting, thereby enabling analysis of the weight data; the specific curve fitting method can be implemented using the prior art, for example, it may include, but not limited to, filtering and calibration etc.
S12, Calculating, according to a preset time interval, a mean value and standard deviation of all the weight data within the time interval; if the calculated standard deviation is less than a preset deviation, recording the calculated mean value of the weight data as a weight-sensing value for the time interval; if the calculated standard deviation is greater than or equal to the preset deviation, discarding the weight data within the time interval.
S13, When the door body is opened, determining a weight before opening based on multiple weight-sensing values recorded from previous closing to current opening of the door body; after the door body is closed, determining a weight after closing based on multiple weight-sensing values recorded after current closing of the door body; and determining currently sold goods according to a difference between the weight before opening and the weight after closing.

Through the above method, when recording data, the mean values and standard deviations of continuously collected weight data are calculated at preset time intervals, and the weight data with deviations exceeding the preset deviation is discarded; after the door body completes one opening and closing, the weight before opening and the weight after closing are obtained, and the sold goods is determined by the difference therebetween. The goods identification method has high accuracy and high efficiency.

It should be noted that in step S11, the total weight change data collected by the four gravity sensors 3 is performed curve fitting by the signal processing board 7, which is communicatively connected with the four gravity sensors 3 respectively.

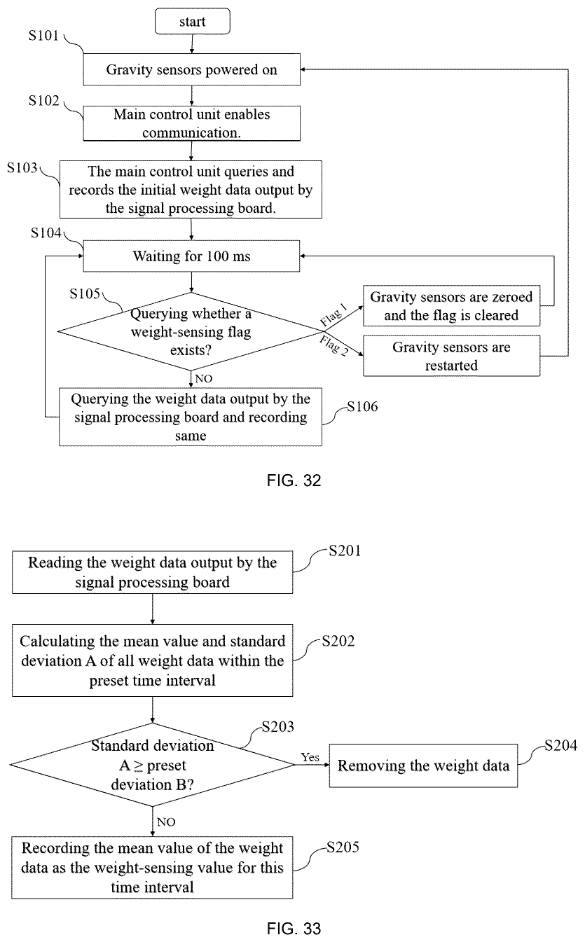

In some embodiments, to ensure sufficient weight data is collected for accurate subsequent data removal, the weight data after curve fitting is output every 100 ms. Specifically, FIG. 32 shows a flowchart of the controller receiving the weight data output by the signal processing board 7. As shown in FIG. 32, the steps for the controller to receive and record the weight data output by the signal processing board 7 are as follows:
S101, the gravity sensors 3 are powered on;
S102, the controller 4 opens the RS485 communication interface;
S103, after waiting for 5 s, the controller 4 starts to query the initial weight data output by the signal processing board 7 and records same;
S104, waiting for 100 ms;
S105, querying whether a weight-sensing flag exists (flag 1 is a weight-sensing zeroing flag; when the initial weight data in an empty shelf state is not 0, or when the controller 4 sends a zeroing command, the flag 1 is set; flag 2 is a weight-sensing restart flag; when no weight data is received, or when controller 4 sends a restart command, the flag 2 is set); if the flag 1 exists, gravity sensors 3 are zeroed and the flag 1 is cleared, returning to S104; if the flag 2 exists, gravity sensors 3 are restarted, returning to S101; if no flag exists, enter into S106;
S106: Querying the weight data output by signal processing board 7 and recording same, and returning to S104.

FIG. 33 shows a flowchart of the controller analyzing and recording the received weight data. As shown in FIG. 33, after the controller receives the weight data output by the signal processing board 7, the analyzing and recording steps are as follows:
S201, reading the weight data output by the signal processing board 7;
S202, calculating the mean value and standard deviation A of all weight data within the preset time interval;
S203, determining whether the standard deviation A is greater than or equal to the preset deviation B; if yes, enter into S204; if no, enter into S205;
S204, removing all weight data in this time interval;
S205, recording the calculated mean value of the weight data as the weight-sensing value for this time interval.

It should be noted that the formula for calculating the standard deviation A is as follows:

$$A = \sqrt{\frac{{\sum }_{i = 1}^{n} {( {x}_{i} - \overline{x} )}^{2}}{n}}$$

In the formula, n is the number of weight data in the time interval to be calculated, xᵢ is the i^{th} weight data in the time interval, and x̅ is the mean value of all weight data within the time interval.

In some embodiments, in S12, the time interval is 500 ms to 1 s. A too long time interval will lead to a long computation time and cannot ensure data removal accuracy; a too short time interval will lead to insufficient data amount, also cannot ensure data removal accuracy.

In some embodiments, in S12, 10% of the weight of the goods to be sold is taken as the preset deviation B. If the preset deviation B is too small, too much data will be removed, failing to guarantee the data amount needed to determine the weight before opening and the weight after closing; if the preset deviation B is too large, data removal will be ineffective.

Regarding S13, it should be noted that the steps for determining the weight before opening of the door body are as follows:
Taking D+1 weight-sensing values continuously recorded from previous closing to current opening of the door body, as C₀, C₁, C₂, . . . , C_{D};
If |C₀−C_{D}≤S and |C_{D}−C_{D/2}|≤S, the weight before opening is C_{D};
If |C₀−C_{D}≤S, |C_{D}−C_{D/2}|>S and |C_{3D/4}−C_{D}≤S, the weight before opening is C_{D};
If |C₀−C_{D}|>S, |C_{D}−C_{D/2}|≤S and |C_{3D/4}−C_{D}|≤S, the weight before opening is C_{D};
If |C₀−C_{D}|>S, |C_{D}−C_{D/2}|>S and |C_{3D/4}−C₀|≤S, the weight before opening is C_{3D/4};
If |C₀−C_{D}|>S, |C_{D}−C_{D/2}|>S, |C_{3D/4}−C₀|>S and |C_{D/2}−C₀|≤S, the weight before opening is C_{D/2};
wherein, C_{D/2} is a weight-sensing value located in the middle of the sequence C₀, C₁, C₂, . . . , C_{D}, or any one of two weight-sensing values located in the middle; C_{3D/4} is a weight-sensing value located in the middle of the sequence C_{D/2}, . . . , C_{D}, or any one of two weight-sensing values located in the middle; S is a preset threshold.

The steps for determining the weight after closing of the door body are as follows:
Taking D′+1 weight-sensing values continuously recorded after closing the door body, as C′₀, C′₁, C′₂, . . . , C′_{D′};
If |C′₀−C′D′|≤S and |C′D′−C′_{D′/2}|≥S, the weight after closing is C′_{D′};
If |C′₀−C′_{D′}|≤S, |C′_{D′}−C′_{D′/2}|>S and |C′_{3D′/4}−C′_{D′}|≤S, the weight after closing is C′_{D′};
If [C′₀−C′_{D′}|>S, |C′_{D′}−C′_{D′/2}|≤S and |C′_{3D′/4}−C′_{D′}|≤S, the weight after closing is C′_{D′};
If |C′₀−C′_{D′}|>S, |C′_{D′}−C′_{D′/2}|>S and |C′_{3D′/4}−C′₀|≤S, the weight after closing is C′_{3D′/4};
If [C′₀−C′_{D′}|>S, [C′_{D′}−C′_{D′/2}|>S, [C′_{3D′/4}−C′₀|>S and |C′_{D′/2}−C′₀|≤S, the weight after closing is C′_{D′/2};
wherein, C′_{D′/2} is a weight-sensing value located in the middle of the sequence C′₀, C′₁, C′₂ . . . , C′_{D′}, or any one of two weight-sensing values located in the middle; C′_{3D′/4} is a weight-sensing value located in the middle of the sequence C′_{D′/2}, . . . , C′_{D′}, or any one of two weight-sensing values located in the middle.

Using the above methods can accurately determine the weight before opening and the weight after closing, thus ensuring the accuracy of goods identification. It should be noted that if the time between the previous closing and the current opening is too short, and no weight-sensing value is recorded, the gravity sensors 3 will not participate in the current goods identification; in this case, the vision-based goods identification method can be used for goods identification.

To ensure accurate goods identification, in some embodiments, 10% of the weight of the goods to be sold is used as the preset threshold S. A too small or too large preset threshold is detrimental to accurately determining the weight before opening and the weight after closing.

To ensure accurate goods identification, in some embodiments, in the steps for determining the weight before opening, the recording time span for the D+1 consecutive weight-sensing values is no less than 20 minutes; in the steps for determining the weight after closing, the recording time span for the D′+1 consecutive weight-sensing values is no less than 20 minutes. It should be noted that, due to the storage capacity limitation of the memory 41, after the recording time span of the stored weight-sensing values exceeds 40 minutes, a data update method is used for recording; that is, recording new weight-sensing values, and deleting the oldest recorded weight-sensing values, to avoid storing too much data in the memory 41.

1. A horizontal intelligent vending freezer, comprising:
a freezer body, provided with an accommodating chamber therein, the accommodating chamber being configured to place goods to be sold;
a visual identification device, configured to collect image information of vending processes, disposed in the accommodating chamber and connected with an inner wall of the freezer body;
gravity sensors, configured to monitor weight change information of the goods in the freezer body before and after sale, and arranged at the freezer body;
a controller, connected with the visual identification device and the gravity sensors; the controller stores types of the goods to be sold and corresponding weight information for each type of goods, and is configured to determine a type and quantity of sold goods based on the weight change information of the goods in the freezer body before and after sale monitored by the gravity sensors and the image information of the vending process collected by the visual identification device, and combined with the stored types of goods and the corresponding weight information for each type of goods.

2. The horizontal intelligent vending freezer according to claim 1, wherein, a compressor room is provided in the freezer body;
the compressor room is arranged adjacent to a left or right side of the freezer body; a step shape is formed within the accommodating chamber corresponding to the compressor room; multiple baskets for placing the goods are provided within the accommodating chamber; the multiple baskets are arranged side-by-side along a left-right direction of the freezer body; wherein, at least one basket is located on the step shape; at least one of the gravity sensors is correspondingly provided between each basket and a bottom of the accommodating chamber; and the gravity sensor is used to collect weight change information of the corresponding basket and the goods therein; or
the compressor room is arranged adjacent to a rear side of the freezer body; a step shape is formed within the accommodating chamber corresponding to the compressor room; a basket for placing the goods is provided within the accommodating chamber, a rear part of the basket extends onto the step shape; the gravity sensors are arranged between a bottom part of the basket in front of the step shape and a bottom of the accommodating chamber; and the gravity sensors are configured to collect weight change information of the basket and the goods therein.

3. The horizontal intelligent vending freezer according to claim 1, further comprising four wheels located at a bottom of the freezer body respectively; wherein there are four gravity sensors installed between the four wheels and the freezer body respectively, and the gravity sensors are configured to collect weight change information of the horizontal intelligent vending freezer.

4. The horizontal intelligent vending freezer according to claim 3, further comprising a signal processing board, wherein the signal processing board is in communication connection with the four gravity sensors respectively, and is configured to perform curve fitting for total weight change data collected by the four gravity sensors in real time, and output weight data after curve fitting in real time; the controller is in communication connection with the signal processing board, and the controller includes a memory and a processor; the memory is used to store the weight data outputted by the signal processing board; and the processor is configured to calculate, according to a preset time interval, a mean value and a standard deviation of all weight data stored in the time interval; if the calculated standard deviation is less than a preset deviation, the calculated mean value of the weight data is taken as a weight-sensing value of the time interval and recorded in the memory; if the calculated standard deviation is greater than or equal to the preset deviation, the weight data within the time interval is discarded; when the door body is opened, multiple weight-sensing values recorded from a previous closing to the current opening of the door body are retrieved from the memory to determine a weight before opening; after the door body is closed, multiple weight-sensing values recorded after current closing of the door body are retrieved from the memory to determine a weight after closing; and a difference between the weight before opening and the weight after closing is used to determine the goods currently been sold.

5. The horizontal intelligent vending freezer according to claim 3, further comprising a bottom support frame arranged at the bottom of the freezer body and supporting the freezer body; wherein the bottom support frame is connected to the bottom of the freezer body, and is internally provided with an accommodating groove; the four gravity sensors are respectively provided at four corners of the bottom support frame and are located in the accommodating groove; the four gravity sensors are symmetrically arranged; a first end of each gravity sensor is connected with the bottom support frame, and a lower part of a second end of the gravity sensor is connected with the wheel to support the bottom support frame on top of the wheel; the wheel does not contact with the bottom support frame;
the first end of the gravity sensor is connected to a top of the bottom support frame via a suspension connector, allowing the gravity sensor to be suspended in the accommodating groove; the wheel has a connecting shaft vertically arranged, and the connecting shaft is threadedly connected to the second end of the gravity sensor.

6. The horizontal intelligent vending freezer according to claim 5, wherein, a limiting step is provided on an outer periphery of the connecting shaft; a top of the limiting step abuts against a bottom of the gravity sensor, thereby restricting a connection position of the gravity sensor on the connecting shaft to a position where a top of the connecting shaft does not protrude beyond a top of the gravity sensor; and a portion of the connecting shaft above the limiting step has an external thread for connecting the gravity sensor.

7. The horizontal intelligent vending freezer according to claim 5, wherein, the connecting shaft is threadedly connected with a locking nut; a top of the locking nut abuts against a bottom of the gravity sensor to lock a connection position of the gravity sensor on the connecting shaft.

8. The horizontal intelligent vending freezer according to claim 1, wherein, the accommodating chamber is internally provided with one or more baskets for placing goods; and the basket is a detachable foldable basket, including a front plate, two side plates and a rear plate; the two side plates are disposed on two opposite sides of the front plate, and are rotatably connected with the front plate, so that the side plates are able to be folded with the front plate; the rear plate is disposed opposite to the front plate in a horizontal direction; two opposite sides of the rear plate are connected with the two side plates, the rear plate is detachably connected with the side plates; and the rear plate, the front plate and the two side plates together define a storage chamber for placing goods.

9. The horizontal intelligent vending freezer according to claim 8, wherein, the basket further includes at least one vertical partition, the vertical partition is disposed within the storage chamber and divides the storage chamber into at least two parallel storage areas; the vertical partition and the two side plates are arranged opposite to each other in the horizontal direction, and two ends of the vertical partition are connected with the front plate and the rear plate respectively; an end of the vertical partition facing the front plate is provided with a hook, the front plate is provided with a connection port, corresponding to the hook; and the hook passes through the connection port and engages with an outer edge of the connection port, to connect the vertical partition with the front plate.

10. The horizontal intelligent vending freezer according to claim 9, wherein, the basket further includes a transverse partition, disposed in the storage area and intersected with the side plate and the vertical partition, to divide the same storage area into at least two sections; the transverse partition is arranged opposite to the front plate in the horizontal direction; one end of the transverse partition is connected with the vertical partition and the other end of the transverse partition is connected with either the vertical partition or the side plate.

11. The horizontal intelligent vending freezer according to claim 10, wherein, a clamping part is provided on the side plate and the vertical partition respectively; the clamping part is located on a side of the side plate facing the storage chamber or a side of the vertical partition connecting to the transverse partition; the transverse partition is provided with a connecting part, the connecting part is provided at an end of the transverse partition connecting with the side plate or the vertical partition; the connecting part is connected with the clamping part, to connect the transverse partition with the vertical partition and/or the side plate.

12. The horizontal intelligent vending freezer according to claim 1, further comprising a master control box, a connecting component and an external device; wherein the master control box is connected with the freezer body, has a first wiring hole and a second wiring hole, and is internally provided with an electrical device; the connecting component is connected with the master control box; the external device is connected with the connecting component, allowing for a detachable connection between the external device and the master control box; wires connecting different types of the external device are connected to the electrical device through the first wiring hole or the second wiring hole.

13. The horizontal intelligent vending freezer according to claim 12, wherein, a side of the external device facing the master control box is provided with a mounting groove; the connecting component is positioned in the mounting groove; the master control box is located at a top of the freezer body, the external device is also located at the top of the freezer body, and a side of the master control box facing the external device is an inclined surface; the external device is arranged obliquely along the inclined surface of the master control box, allowing the side of the external device with the mounting groove to form surface contact with the master control box, and providing support from the master control box.

14. The horizontal intelligent vending freezer according to claim 12, wherein, the connecting component includes a first connector and a second connector; the first connector is connected with the master control box; and the second connector is connected with the external device and is detachably connected with the first connector; the first connector has a first connecting hole, the second connector has a second connecting hole corresponding to the first connecting hole, and a fastener is disposed in both the first connecting hole and the second connecting hole, to make the first connector and the second connector connected.

15. The horizontal intelligent vending freezer according to claim 14, wherein, the first connector has a mounting chamber; a top of the first connector forms a mounting port, and the first connector is provided with a mounting chamber opening facing the external device; the mounting port opens a top of the mounting chamber, and the mounting chamber opening opens a side of the mounting chamber facing the external device; two limiting parts are provided on two opposite sides of the mounting chamber opening, extending along the inclined surface of the master control box; the second connector includes a protrusion part and two extension parts provided at two sides of the protrusion part; the protrusion part is formed by protruding from a middle portion of the second connector towards the external device, and the two extension parts extend along the inclined surface of the master control box; the extension parts of the second connector are inserted into the mounting chamber of the first connector through the mounting port, and the protrusion part closes the mounting chamber opening; the extension parts contact with sides of the limiting parts facing the mounting chamber to prevent the second connector from detaching from the first connector through the mounting chamber opening.

16. A goods identification method for the horizontal intelligent vending freezer according to claim 1, comprising the following steps:
S1, determining possible combinations of types and quantities of sold goods by the controller, based on the weight change information of the goods in the freezer body before and after sale monitored by the gravity sensors, and combined with the types of goods and the corresponding weight information for each type of goods stored in the controller;
S2, if there is only one combination, outputting the type and quantity of the sold goods under the combination as an identification result by the controller; if there are multiple possible combinations, by the controller, comparing the multiple possible combinations with the image information of the vending process collected by the visual identification device, and outputting one combination that is consistent with the image information of the vending process collected by the visual identification device as the identification result.

17. The goods identification method according to claim 16, wherein, the horizontal intelligent vending freezer further comprises four wheels, located at a bottom of the freezer body respectively; there are four gravity sensors installed between the four wheels and the freezer body respectively, and the gravity sensors are configured to collect weight change information of the horizontal intelligent vending freezer; and the step S1 specifically includes the following steps:
S11, collecting, in real time, total weight change data of the freezer body and goods therein relative to an initial time by the four gravity sensors; performing curve fitting for the total weight change data collected by the four gravity sensors, to obtain weight data after curve fitting;
S12, calculating, according to a preset time interval, a mean value and standard deviation of all the weight data within the time interval; if the calculated standard deviation is less than a preset deviation, recording the calculated mean value of the weight data as a weight-sensing value for the time interval; if the calculated standard deviation is greater than or equal to the preset deviation, discarding the weight data within the time interval;
S13, when the door body is opened, determining a weight before opening based on multiple weight-sensing values recorded from previous closing to current opening of the door body; after the door body is closed, determining a weight after closing based on multiple weight-sensing values recorded after current closing of the door body; and determining currently sold goods according to a difference between the weight before opening and the weight after closing.

18. The goods identification method according to claim 17, wherein, in the step S11, the weight data after curve fitting is output every 100 ms;
in the step S12, the time interval is 500 ms to 1 s;
in the step S12, 10% of a weight of the goods to be sold is taken as the preset deviation.

19. The goods identification method according to claim 17, wherein, in the step S13, steps for determining the weight before opening are as follows:
taking D+1 weight-sensing values continuously recorded from previous closing to current opening of the door body, as C₀, C₁, C₂, . . . , C_{D};
If |C₀−C_{D}|≤S and |C_{D}−C_{D/2}|≤S, the weight before opening is C_{D};
If |C₀−C_{D}|≤S, |C_{D}−C_{D/2}|>S and |C_{3D/4}−C_{D}|≤S, the weight before opening is C_{D};
If |C₀−C_{D}|>S, |C_{D}−C_{D/2}|≤S and |C_{3D/4}−C_{D}|≤S, the weight before opening is C_{D};
If |C₀−C_{D}|>S, |C_{D}−C_{D/2}|>S and |C_{3D/4}−C₀|≤S, the weight before opening is C_{3D/4};
If |C₀−C_{D}|>S, |C_{D}−C_{D/2}|>S, |C_{3D/4}−C₀|>S and |C_{D/2}−C₀|≤S, the weight before opening is C_{D/2};
wherein, C_{D/2} is a weight-sensing value located in a middle of the sequence C₀, C₁, C₂, . . . , C_{D}, or any one of two weight-sensing values located in the middle; C_{3D/4} is a weight-sensing value located in a middle of the sequence C_{D/2}, . . . , C_{D}, or any one of two weight-sensing values located in the middle; S is a preset threshold;
steps for determining the weight after closing are as follows:
taking D′+1 weight-sensing values continuously recorded after closing the door body, as C′₀, C′₁, C′₂, . . . , C′_{D′};
If [C′₀−C′_{D′}|≤S and |C′_{D′}−C′_{D′/2}|≤S, the weight after closing is C′_{D′};
If |C′₀−C′_{D′}|≤S, |C′_{D′}−C′_{D′/2}|>S and |C′_{3D′/4}−C′_{D′}|≤S, the weight after closing is C′_{D′};
If [C′₀−C′_{D′}|>S, |C′_{D′}−C′_{D′/2}|≤S and |C′_{3D′/4}−C′_{D′}|≤S, the weight after closing is C′_{D′};
If |C′₀−C′_{D′}|>S, |C′_{D′}−C′_{D′/2}|>S and |C′_{3D′/4}−C′₀|≤S, the weight after closing is C′_{3D′/4};
If [C′₀−C′_{D′}|>S, [C′_{D′}−C′_{D′/2}|>S, |C′_{3D′/4}−C′₀|>S and [C′_{D′/2}−C′₀|≤S, the weight after closing is C′_{D′/2};
wherein, C′_{D′/2} is a weight-sensing value located in a middle of the sequence C′₀, C′₁, C′₂, . . . , C′_{D′}, or any one of two weight-sensing values located in the middle; C′_{3D′/4} is a weight-sensing value located in a middle of the sequence C′_{D′/2}, . . . , C′_{D′}, or any one of two weight-sensing values located in the middle.

20. The goods identification method according to claim 19, wherein, 10% of a weight of the goods to be sold is used as the preset threshold S; in the steps for determining the weight before opening, a recording time span for the D+1 consecutive weight-sensing values is no less than 20 minutes; in the steps for determining the weight after closing, a recording time span for the D′+1 consecutive weight-sensing values is no less than 20 minutes.
